(19) United States
(12) Patent Application Publication
(10) Pub. No.: US 2026/0027655 A1
(43) Pub. Date: Jan. 29, 2026

(54) LASER IRRADIATION APPARATUS AND LASER IRRADIATION METHOD USING THE SAME

(71) Applicants: Samsung Display Co., LTD., Yongin-si (KR); The Research Foundation for The State University of New York, Albany,, NY (US)

(72) Inventors: Seungkuk KUK, Yongin-si (KR); Insoo KIM, Albany, NY (US); David HWANG, Albany, NY (US)

(21) Appl. No.: 19/219,096

(22) Filed: May 27, 2025

(30) Foreign Application Priority Data
Jul. 25, 2024 (KR) 10-2024-0098915

(51) Int. Cl. B23K 26/352; B23K 26/06

(52) U.S. Cl. CPC B23K 26/352; B23K 26/0643

(57) ABSTRACT

A laser irradiation apparatus includes a first laser module emitting a first laser onto a substrate, and a second laser module emitting, onto the substrate, a second laser which is different from the first laser and includes a pulse laser. The first laser increases a temperature of the substrate to between a first temperature or higher and a second temperature or lower which is higher than the first temperature. The second laser is provided on the substrate for a time at which a temperature of the substrate is higher than the first temperature so as to heal a surface of the substrate.

This application claims priority to Korean Patent Application No. 10-2024-0098915, filed on Jul. 25, 2024, and all the benefits accruing therefrom under 35 U.S.C. § 119, the content of which in its entirety is herein incorporated by reference.

### BACKGROUND

### 1. Field

The invention relates generally to a laser irradiation apparatus, and more particularly to a laser irradiation apparatus and a laser irradiation method using the same.

### 2. Description of Related Art

Electronic apparatuses such as a smart phone, a tablet computer, a laptop computer, a car navigation system, and a smart television are being developed. Such electronic apparatuses are equipped with display devices for providing information.

Various types of display devices are being developed to satisfy a users' User Experience/User Interface (UX/UI). A display device for providing a wide display region and a narrow non-display region is being developed.

Generally, a laser apparatus may be used during a process of manufacturing an electrical-electronic device, such as a display device. Specifically, the laser apparatus may be used for drilling, cutting, cleaning, marking, scanning, crystallizing, and surface-modifying a workpiece.

### SUMMARY

The invention provides a laser irradiation apparatus which reduces damage of a substrate, and a laser irradiation method using the same.

An embodiment provides a laser irradiation apparatus including a first laser module configured to emit a first laser onto a substrate and a second laser module configured to emit, onto the substrate, a second laser which is different from the first laser and which includes a pulse laser. The first laser increases a temperature of the substrate to a first temperature or higher and a second temperature or lower which is higher than the first temperature. The second laser is provided onto the substrate for a time at which a temperature of the substrate is higher than the first temperature and which heals a surface of the substrate.

In an embodiment, a laser irradiation method includes irradiating a substrate with a first laser by using a first laser module to increase a temperature of the substrate to a first temperature or higher and a second temperature or lower which is higher than the first temperature and irradiating the substrate, by using a second laser module, with a second laser which is different from the first laser and includes a pulse laser. The substrate is irradiated with the second laser for a time at which a temperature of the substrate is higher than the first temperature, and the second laser heals a surface of the substrate.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 is a top down view graphically illustrating components of a laser irradiation apparatus, according to an embodiment;

FIG. 2A is a view exemplarily illustrating pulses of lasers illustrated in FIG. 1, according to an embodiment;

FIG. 2B is a view illustrating a temperature of a substrate illustrated in FIG. 1 according to a time, according to an embodiment;

FIG. 3 is a view illustrating a temperature of a substrate illustrated in FIG. 1 according to a time, according to an embodiment;

FIG. 4A is a view illustrating, according to a Comparative Example, a temperature of the substrate illustrated in FIG. 1 according to a time;

FIG. 4B is a view illustrating a substrate, according to a Comparative Example;

FIG. 5 is a perspective view illustrating a display device, according to an embodiment;

FIG. 6 is an exploded perspective view of a display device, according to an embodiment; and

FIG. 7 is a cross-sectional view of a display panel, according to an embodiment.

### DETAILED DESCRIPTION

The invention may be implemented in various modifications and have various forms, and specific embodiments are illustrated in the drawings and are described in detail in the text. It is to be understood, however, that the invention is not intended to be limited to the particular forms disclosed herein, but on the contrary, is intended to cover all modifications, equivalents, and alternatives falling within the spirit and scope of the invention.

In this specification, it will be understood that when an element (or region, layer, portion, or the like) is referred to as being “on”, “connected to” or “coupled to” another element, it may be directly disposed/connected/coupled to another element, or intervening elements may be disposed therebetween.

Like reference numerals or symbols refer to like elements throughout. Also, in the drawings, the thickness, the ratio, and the dimension of the elements are exaggerated for effective description of the technical contents.

The term “and/or” includes all combinations of one or more of the associated listed elements.

Although the terms first, second, etc., may be used to describe various elements, these elements should not be limited by these terms. These terms are only used to distinguish one element from another element. For example, a first element may be referred to as a second element, and similarly, a second element may also be referred to as a first element without departing from the scope of the invention. The singular forms include the plural forms as well, unless the context clearly indicates otherwise.

Also, the terms such as “below”, “lower”, “above”, “upper” and the like, may be used for the description to describe one element's relationship to another element illustrated in the figures. It will be understood that the terms have a relative concept and are described on the basis of the orientation depicted in the figures.

Unless otherwise defined, all terms (including technical and scientific terms) used herein have the same meaning as commonly understood by one of ordinary skill in the art to which the present disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Hereinafter, embodiments of the invention are described with reference to the drawings.

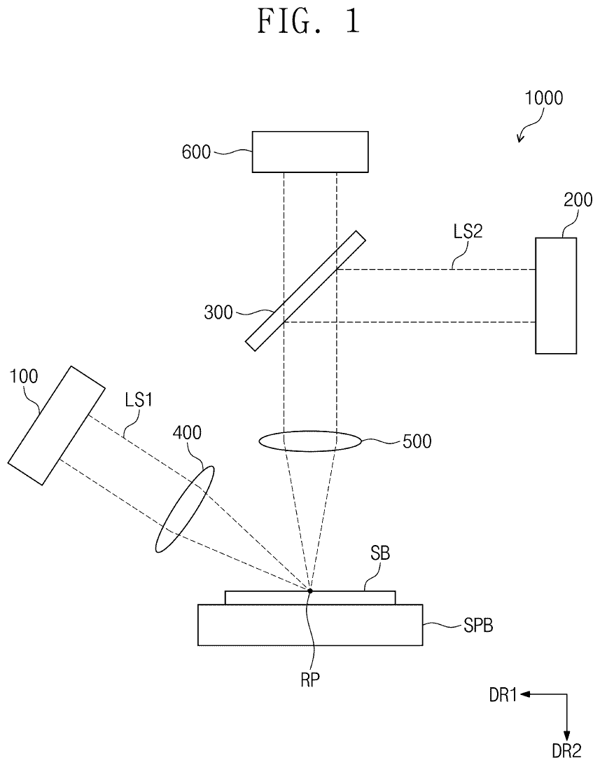

FIG. 1 is a view graphically illustrating components of a laser irradiation apparatus, according to an embodiment.

In an embodiment and referring to FIG. 1, a laser irradiation apparatus 1000 includes a first laser module 100, a second laser module 200, a reflective mirror 300, a first focusing lens 400, a second focusing lens 500, and an image capturing unit 600.

In an embodiment, the first laser module 100 may generate a first laser LS1, and a substrate SB may be irradiated with the emitted first laser LS1. The first laser LS1 may include a carbon dioxide (CO₂) laser. The first laser LS1 may have a wavelength range of about 10 μm to about 11 μm. For example, the first laser LS1 may have a wavelength of about 10.6 μm. The carbon dioxide (CO₂) laser may have a relatively higher output than an ultraviolet laser. An output of the first laser LS1 may vary according to a time. The detailed description thereof will be described later.

In an embodiment, the first focusing lens 400 may be disposed in a path of the first laser LS1 and be provided with the first laser LS1. The first focusing lens 400 functions to focus beams toward a predetermined focal point while transmitting the beams. Accordingly, the first laser LS1 may be focused toward the predetermined focal point by the first focusing lens 400 while passing through the first focusing lens 400. For example, the first focusing lens 400 may include a convex lens.

In an embodiment, the second laser module 200 may generate a second laser LS2, and the substrate SB may be irradiated with the emitted second laser LS2. The second laser LS2 may include an ultraviolet (UV) laser. The second laser LS2 may have a wavelength range of about 300 nm to about 1064 nm. For example, the second laser LS2 may have a wavelength range of about 300 nm to about 400 nm. However, the invention is not limited thereto, and the second laser LS2 may include deep ultraviolet (DUV). In this case, the second laser LS2 may have a wavelength range of about 157 nm to about 300 nm. The second laser LS2 may have an output range of about 2 W to about 5 W. The second laser LS2 may be emitted after the first laser LS1 is emitted. The time for which the second laser LS2 is emitted may be shorter than the time for which the first laser LS1 is emitted. The detailed description thereof will be described later.

In an embodiment, the reflective mirror 300 is horizontally disposed with the second laser module 200 in a first direction DR1, and is provided with the second laser LS2 emitted from the second laser module 200. The reflective mirror 300 may be inclined with respect to the first direction DR1, and an inclination angle of the reflective mirror 300 may be set as an angle at which a beam traveling in the first direction DR1 may be headed toward a second direction DR2. For example, the first direction DR1 may be a horizontal direction, and the second direction DR2 may be a downward direction.

In an embodiment, the reflective mirror 300 reflects the second laser LS2 provided from the second laser module 200, and changes the traveling direction of the second laser LS2 toward the second direction DR2. The second laser LS2 reflected onto the reflective mirror 300 is provided to the second focusing lens 500. Although not illustrated, a switching part which determines whether to switch the second laser LS2 may be further included between the reflective mirror 300 and the second laser module 200. The switching part may be disposed in a path of the second laser LS2 and determine whether the second laser LS2 passes through the switching part to be provided to the reflective mirror 300. That is, a user may adjust, by using the switching part, a time at which the second laser LS2 is provided onto the substrate SB.

In an embodiment, the second focusing lens 500 may be disposed in the path of the second laser LS2 and may be provided with the second laser LS2. The second focusing lens 500 functions to focus beams toward a predetermined focal point while transmitting the beams. Accordingly, the second laser LS2 may be focused toward the predetermined focal point by the second focusing lens 500 while passing through the second focusing lens 500. For example, the second focusing lens 500 may include a convex lens.

In an embodiment, the substrate SB may be disposed on a support part SPB. In another embodiment, the support part SPB may be omitted. The substrate SB disposed on the support part SPB may be irradiated with the first laser LS1 and the second laser LS2. For example, a reference point RP of the substrate SB may be irradiated with the first laser LS1 and the second laser LS2. The substrate SB may be a glass substrate which is used for a display device, or a glass substrate which is used for a window.

In an embodiment, the image capturing unit 600 may be disposed on the reflective mirror 300. Specifically, the image capturing unit 600 may be disposed above the substrate SB and capture a point at which the first laser LS1 and the second laser LS2 are provided onto the substrate SB (for example, the reference point RP). When the first laser LS1 and the second laser LS2 are provided at different points, a user may correct positions of the first laser module 100 and the second laser module 200 on the basis of an image of the captured reference point RP.

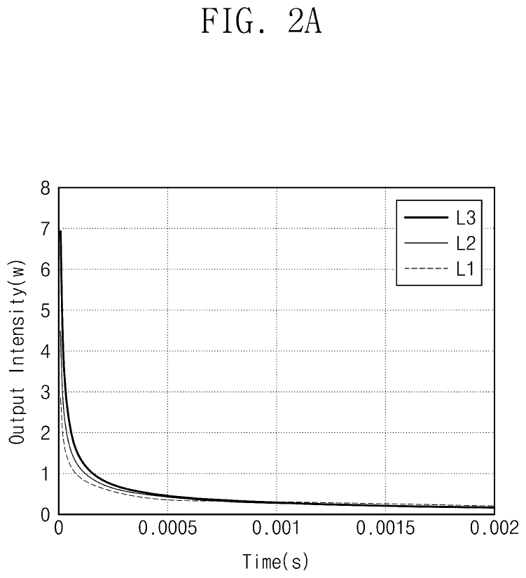

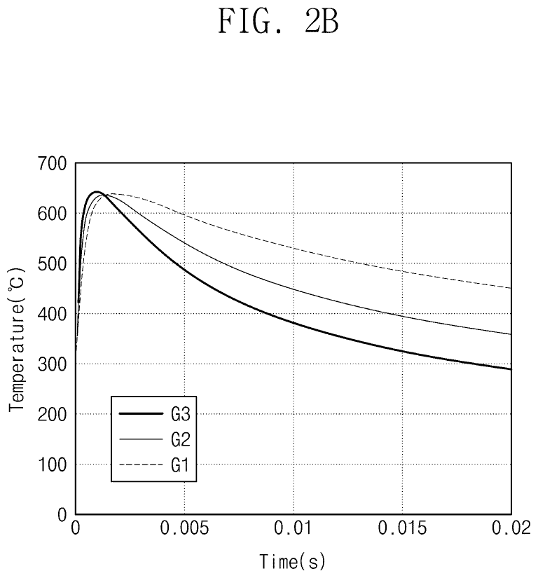

FIG. 2A is a view exemplarily illustrating pulses of the lasers illustrated in FIG. 1, according to an embodiment. FIG. 2B is a view illustrating a temperature of the substrate illustrated in FIG. 1 according to a time, according to an embodiment. For example, FIG. 2A is a view exemplarily illustrating pulses L1, L2, and L3 of the first laser LS1 illustrated in FIG. 1, and FIG. 2B is a view illustrating a temperature of the substrate SB (see FIG. 1) according to a time on the basis of the pulses L1, L2, and L3 illustrated in FIG. 2A.

According to an embodiment, an output of the first laser LS1 (see FIG. 1) may vary according to a time. For example, an output intensity of the first laser LS1 may be given by Equation 1, immediately below:

$$P = c {t}^{- n} , \qquad Equation ( 1 )$$

where P denotes the output intensity of the first laser LS1, t denotes a time, c denotes a proportional constant, and n denotes a constant in a range of about 0.5 to about 0.7. That is, the output of the first laser LS1 may decrease in the form of an exponential function.

In an embodiment and referring to FIGS. 1 to 2B together, when the substrate SB is irradiated with the first laser LS1, a temperature of the substrate SB may increase. Also, when the output of the first laser LS1 decreases, the temperature of the substrate SB may decrease again. The tendency that the temperature of the substrate SB decreases again may be referred to as a cooling rate. When the cooling rate is denoted as CR, the cooling rate may be proportional to Equation 2 immediately below:

$$CR ∝ {t}^{- n} . \qquad Equation ( 2 )$$

That is, Equation 2 may be the same as Equation 3, immediately below:

$$CR = {ct}^{- n} . \qquad Equation ( 3 )$$

Accordingly, the output intensity P of the first laser LS1 may be the same as the cooling rate CR of the substrate SB.

In an embodiment, the pulses L1, L2, and L3 illustrated in FIG. 2A indicate output intensities of the first laser LS1 according to a time at which the first laser LS1 (see FIG. 1) is formed in accordance with Equation 1 described above. For example, the first pulse L1 is an output intensity of the first laser LS1 according to a time given by Equation 1, where c is about 0.0091 and n is about 0.5. The second pulse L2 is an output intensity of the first laser LS1 according to a time given by Equation 1, where c is about 0.0045 and n is about 0.6. The third pulse L3 is an output intensity of the first laser LS1 according to a time given by Equation 1, where c is about 0.0022 and n is about 0.7. In an embodiment, the pulses L1, L2, and L3 may each be in a form of a single pulse. According to an embodiment, the first laser LS1 may be provided as the third pulse L3.

In an embodiment, a first graph G1 illustrated in FIG. 2B shows a temperature of the substrate SB according to a time, when the substrate SB (see FIG. 1) is irradiated with the first laser LS1 (see FIG. 1) on the basis of the first pulse L1 illustrated in FIG. 2A. A second graph G2 shows a temperature of the substrate SB according to a time, when the substrate SB is irradiated with the first laser LS1 on the basis of the second pulse L2 illustrated in FIG. 2A. A third graph G3 shows a temperature of the substrate SB according to a time, when the substrate SB is irradiated with the first laser LS1 on the basis of the third pulse L3 illustrated in FIG. 2A.

In an embodiment and referring to the graphs G1, G2, and G3, it may be confirmed that the substrate SB has the maximum temperature of about 600° C. to about 700° C. For example, the substrate SB may have the maximum temperature range of about 600° C. to about 650° C. In an embodiment, the substrate SB may include glass. The substrate SB may have an annealing temperature of about 600° C. and a softening temperature of about 700° C. That is, the maximum temperature of the substrate SB may be between the annealing temperature or higher and the softening temperature or lower.

In an embodiment, when the temperature of the substrate SB is between the annealing temperature or higher and the softening temperature or lower, a uniform internal structure of the substrate SB is achieved and stress is removed, so that scratches, etc., occurring in the exterior of the substrate SB may be removed. Referring to the graphs G1, G2, and G3, it may be confirmed that in the first graph G1, the time for which the temperature of the substrate SB is between the annealing temperature or higher and the softening temperature or lower is the longest.

That is, the first graph G1 shows the slowest temperature decrease in the substrate SB. For example, according to first graph G1, the time, for which the temperature of the substrate SB is between the annealing temperature or higher and the softening temperature or lower, may be about 0.004 seconds.

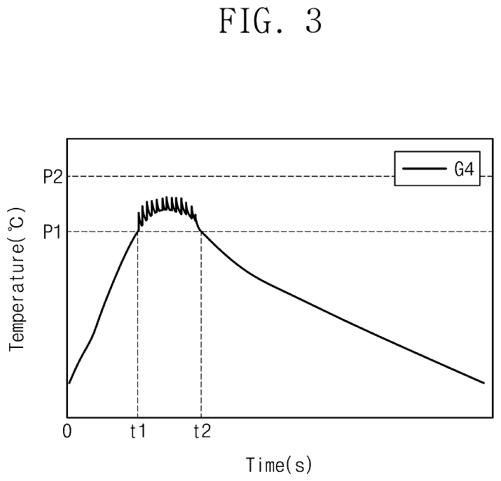

FIG. 3 is a view illustrating a temperature of the substrate illustrated in FIG. 1 according to a time, according to an embodiment. For example, FIG. 3 is a view illustrating a temperature of a substrate SB according to a time, when the substrate SB is irradiated with the first and second lasers LS1 and LS2 illustrated in FIG. 1 at the same time.

In an embodiment and referring to FIGS. 1 to 3 together, a fourth graph G4 shows a temperature of the substrate SB according to a time, when the substrate SB is irradiated with the first laser LS1 on the basis of the first pulse L1 and the substrate SB is irradiated with the second laser LS2.

According to an embodiment, a temperature, of the substrate SB, corresponding to the annealing temperature may be defined as a first temperature P1, and a temperature, of the substrate SB, corresponding to the softening temperature may be defined as a second temperature P2. When the substrate SB is a glass substrate, a temperature of about 600° C. illustrated in FIG. 2B may be the first temperature P1, and a temperature of about 700° C. may be the second temperature P2. However, the invention is not limited thereto, and a value of each of the first temperature P1 and the second temperature P2 may be variable according to a component corresponding to the substrate SB.

In an embodiment, the maximum temperature of the substrate SB may be between the first temperature P1 or higher and the second temperature P2 or lower. When the temperature of the substrate SB is the first temperature P1, the time may be defined as a first time t1 and a second time t2. That is, the time at which the temperature of the substrate SB initially reaches the first temperature P1 when the temperature of the substrate SB increases may be defined as the first time t1, and the time at which the temperature of the substrate SB reaches the first temperature P1 when the temperature of the substrate SB decreases may be defined as the second time t2.

In an embodiment, the substrate SB may be irradiated with the second laser LS2 at a time between the first time t1 and the second time t2. The substrate SB may be irradiated with the second laser LS2 while the substrate SB is irradiated with the first laser LS1. The second laser LS2 may include a pulse laser, and a unit of a pulse period of the second laser LS2 may be picoseconds (ps) or nanoseconds (ns). That is, due to the pulse period of the second laser LS2, the temperature of the substrate SB may rapidly increase or decrease at a time between the first time t1 and the second time t2.

In an embodiment, when the temperature of the substrate SB is not between the annealing temperature or higher and the softening temperature or lower, the substrate SB may be damaged due to a short pulse period of the second laser LS2. Since the substrate SB is irradiated with the second laser LS2, according to an embodiment, at a temperature the substrate SB of which is between the first temperature P1 or higher and the second temperature P2 or lower, the substrate SB may not be damaged, and thus it is possible to perform a healing process capable of removing scratches, etc., occurring in a surface of the substrate SB, for a sufficient time.

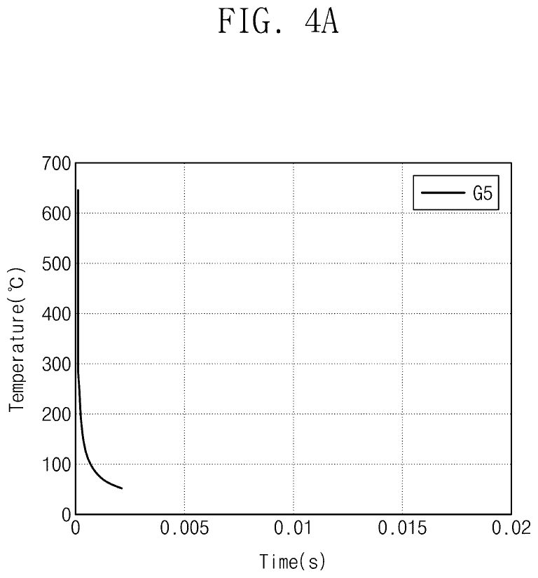

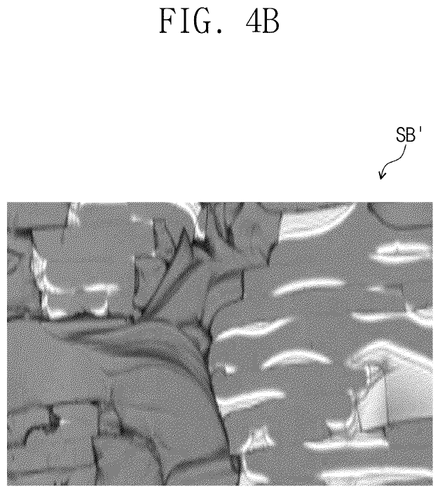

FIG. 4A is a view illustrating, according to Comparative Example, a temperature of the substrate illustrated in FIG. 1 according to a time. FIG. 4B is a view illustrating a substrate according to Comparative Example. For example, FIG. 4A is a view illustrating a temperature of a substrate SB′ according to a time, when the substrate SB′ is irradiated with lasers according to Comparative Example. FIG. 4B is a plan view of the substrate SB′ when the substrate SB′ is processed according to the graph illustrated in FIG. 4A.

A fifth graph G5 shows a temperature of the substrate SB′ according to a time, when the substrate SB′ is provided with the laser according to Comparative Example as a single pulse for a duration of picoseconds (ps) or nanoseconds (ns). Referring to the fifth graph G5, it may be confirmed that the temperature of the substrate SB′ rapidly decreases at the maximum temperature of the substrate SB′. That is, it may be confirmed that the cooling rate of the fifth graph G5 is greater than that of the first graph G1 illustrated in FIG. 2B. When the cooling rate is great, non-uniformity of structures may be caused during the processing or polishing of the substrate SB′, which may result in damage of the substrate SB′ as illustrated in FIG. 4B.

In an embodiment and referring to FIGS. 1 to 4B together, since the laser irradiation apparatus 1000 includes the first laser module 100 providing the first laser LS1 and the second laser module 200 providing the second laser LS2 at a time between the first time t1 and the second time t2 according to the above-described Equation 1, the substrate SB has the reduced cooling rate, and thus scratches occurring in the surface of the substrate SB may be effectively removed by the second laser LS2.

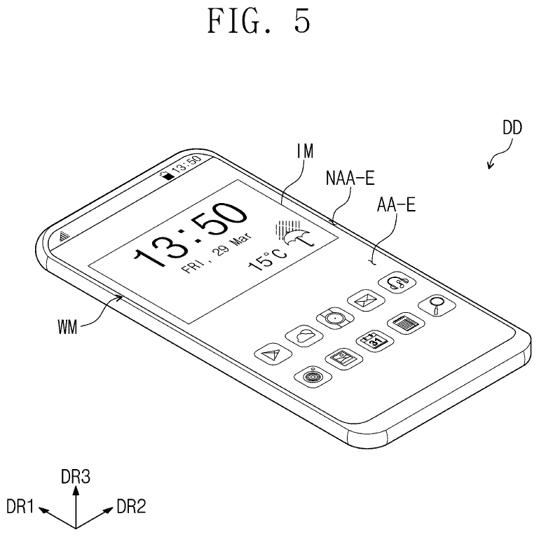

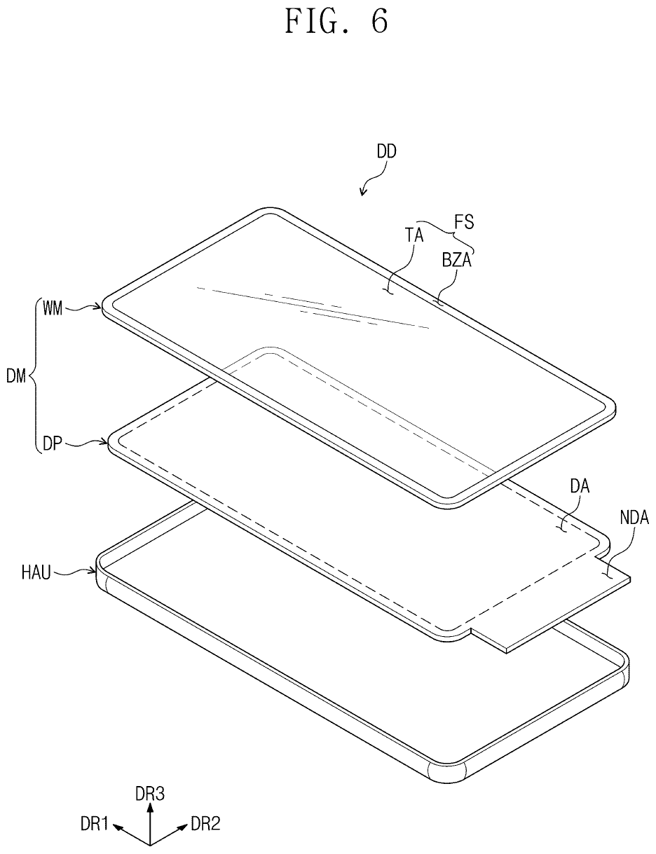

FIG. 5 is a perspective view illustrating a display device, according to an embodiment. FIG. 6 is an exploded perspective view of a display device, according to an embodiment.

In an embodiment, a display device DD may display an image IM through an active region AA-E, where the active region AA-E may include a flat surface defined by a first direction DR1 and a second direction DR2. A peripheral region NAA-E is disposed adjacent to the active region AA-E, where the peripheral region NAA-E may surround the active region AA-E. However, the peripheral region NAA-E may be disposed adjacent to only one side of the active region AA-E or may also be omitted.

The display device DD, according to an embodiment, may include a housing HAU and a display module DM, where the display module DM, according to an embodiment, may include a display panel DP and a window member WM.

In an embodiment, the window member WM may cover the entire exterior of the display module DM and may include a transmission region TA and a bezel region BZA. A front surface of the window member WM including the transmission region TA and the bezel region BZA may correspond to a front surface of the display device DD. The transmission region TA may correspond to the active region AA-E of the display device DD illustrated in FIG. 1, and the bezel region BZA may correspond to the peripheral region NAA-E of the display device DD illustrated in FIG. 5. The substrate SB illustrated in FIG. 1 may include the glass included in the window member WM. That is, a reliable display device DD the window member WM of which has reduced damage may be provided by using the laser irradiation apparatus 1000, according to an embodiment.

In an embodiment, the transmission region TA may be an optically transparent region. The bezel region BZA may be a region having a relatively lower light transmittance than the transmission region TA. The bezel region BZA may have a predetermined color. The bezel region BZA may be disposed adjacent to the transmission region TA and surround the transmission region TA. However, not only the bezel region BZA may be disposed adjacent to only one side of the transmission region TA, but also a portion thereof may be omitted.

In an embodiment, the display panel DP may include a display region DA and a non-display region NDA around the display region DA. The display region DA may be a region activated in response to an electrical signal. In an embodiment, the display region DA may be a region in which the image IM (see FIG. 5) is displayed. The display region DA of the display panel DP may correspond to the active region AA-E of the display device DD illustrated in FIG. 5, and the non-display region NDA of the display panel DP may correspond to the peripheral region NAA-E of the display device DD illustrated in FIG. 5. The transmission region TA may overlap at least a portion of the display region DA. The non-display region NDA may be a region to be covered by the bezel region BZA.

In an embodiment and although not illustrated in FIGS. 5 and 6, an input-sensing portion may be provided on the display panel DP, where the input-sensing portion may detect an external input applied from the outside. The external input may be a user's input. The user's input may include various types of external inputs such as a part of a user's body, light, heat, pen, or pressure. The input-sensing portion may be directly disposed on the display panel DP, or also be coupled to the display panel DP via an additional adhesive member.

In an embodiment, the display panel DP, etc., may be accommodated in a housing HAU, where the housing HAU may be coupled to the window member WM.

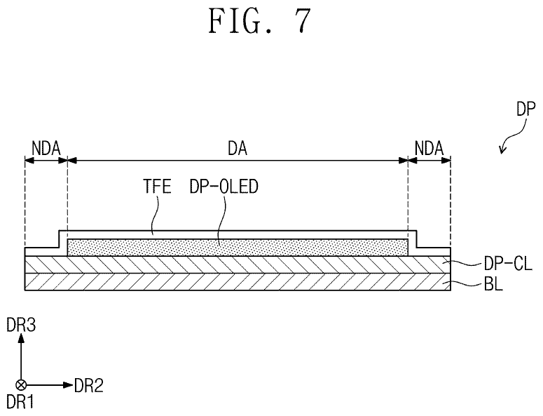

FIG. 7 is a cross-sectional view of a display panel, according to an embodiment. For example, FIG. 7 illustrates a cross section of a display panel DP when viewed from the first direction DR1.

In an embodiment and referring to FIG. 7, the display panel DP may include a base layer BL, a circuit layer DP-CL disposed on the base layer BL, a display element layer DP-OLED disposed on the circuit layer DP-CL, and an encapsulation layer TFE disposed on the display element layer DP-OLED. The display panel DP may include a display region DA and a non-display region NDA around the display region DA.

In an embodiment, the base layer BL may include a flexible plastic material such as polyimide (PI). The display element layer DP-OLED may be disposed on the display region DA.

In an embodiment, a plurality of pixels may be disposed on the circuit layer DP-CL and the display element layer DP-OLED, where each of the plurality of pixels may include transistors disposed on the circuit layer DP-CL, and a light-emitting element disposed on the display element layer DP-OLED and connected to the transistors. The configuration of the pixels will be described later in detail.

In an embodiment, the encapsulation layer TFE may be disposed on the circuit layer DP-CL so as to cover the display element layer DP-OLED. The encapsulation layer TFE may protect the pixels against moisture, oxygen, and external foreign substances.

In an embodiment, a laser irradiation apparatus may include a first laser module providing a first laser and a second laser module providing a second laser which is different from the first laser and which has a short pulse period, according to an output determined by an Equation including an exponential function. It is possible not only to reduce a cooling rate of a substrate by using the first laser but also to remove scratches occurring in a surface of the substrate by using the second laser.

Although the embodiments of the invention have been described, it is understood that the invention should not be limited to these embodiments, but rather various changes and modifications can be made by one ordinary skilled in the art within the spirit and scope of the invention. Therefore, the technical scope of the invention should not be limited to the contents described in the detailed description of the specification. Moreover, the embodiments or parts of the embodiments may be combined in whole or in part without departing from the scope of the invention.

What is claimed is:

1. A laser irradiation apparatus comprising:
a first laser module for emitting a first laser onto a substrate; and
a second laser module for emitting, onto the substrate, a second laser which is different from the first laser and which includes a pulse laser,
wherein the first laser increases a temperature of the substrate to between a first temperature or higher and a second temperature or lower, wherein the second temperature is higher than the first temperature, and
wherein the second laser is provided onto the substrate for a time at which a temperature of the substrate is higher than the first temperature, and heals a surface of the substrate.

2. The laser irradiation apparatus of claim 1, wherein an output intensity of the first laser is given by:
$$P = {ct}^{- n} , \qquad Equation ( 1 )$$
where P denotes the output intensity of the first laser, t denotes a time, c denotes a proportional constant, and n denotes a constant in a range of about 0.5 to about 0.7.

3. The laser irradiation apparatus of claim 2, wherein the proportional constant is about 0.0022 or less.

4. The laser irradiation apparatus of claim 1, wherein the first laser comprises a carbon dioxide laser and has a wavelength range of about 10 μm to about 11 μm.

5. The laser irradiation apparatus of claim 1, wherein the second laser comprises an ultraviolet (UV) laser and has a wavelength range of about 300 nm to about 400 nm.

6. The laser irradiation apparatus of claim 1, wherein the substrate comprises glass.

7. The laser irradiation apparatus of claim 6, wherein the first temperature corresponds to an annealing temperature of the substrate, and
the second temperature corresponds to a softening temperature of the substrate.

8. The laser irradiation apparatus of claim 7, wherein the first temperature is about 550° C. to about 600° C., and
the second temperature is about 700° C. to about 750° C.

9. The laser irradiation apparatus of claim 8, wherein the substrate has a maximum temperature of about 600° C. to about 700° C.

10. The laser irradiation apparatus of claim 8, wherein a time range, for which a temperature of the substrate is between the first temperature or higher and the second temperature or lower, is between about 0.004 seconds to about 0.005 seconds.

11. The laser irradiation apparatus of claim 1, further comprising a switching part disposed in a path of the second laser, wherein the switching part determines whether to switch the second laser.

12. The laser irradiation apparatus of claim 1, further comprising a reflective mirror disposed in a path of the second laser, wherein the reflective mirror changes the path of the second laser to irradiate the substrate with the second laser.

13. A laser irradiation method, the method comprising:
irradiating a substrate with a first laser by using a first laser module to increase a temperature of the substrate to between a first temperature or higher and a second temperature or lower, wherein the second temperature is higher than the first temperature; and
irradiating the substrate, by using a second laser module having a second laser which is different from the first laser and which includes a pulse laser,
wherein the substrate is irradiated with the second laser for a time at which a temperature of the substrate is higher than the first temperature, and the second laser heals a surface of the substrate.

14. The method of claim 13, wherein an output intensity of the first laser is given by:
$$P = {ct}^{- n} , \qquad Equation ( 1 )$$
where P denotes the output intensity of the first laser, t denotes a time, c denotes a proportional constant, and n denotes a constant in a range of about 0.5 to about 0.7.

15. The method of claim 13, wherein at least one of,
the first laser comprises a carbon dioxide laser and has a wavelength range of about 10 μm to about 11 μm.

16. The method of claim 13, wherein the second laser comprises an UV laser and has a wavelength range of about 300 nm to about 1064 nm.

17. The method of claim 13, wherein the substrate comprises glass, and wherein
the first temperature corresponds to an annealing temperature of the substrate, and
the second temperature corresponds to a softening temperature of the substrate.

18. The method of claim 17, wherein the first temperature is about 550° C. to about 600° C., and
the second temperature is about 700° C. to about 750° C.

19. The method of claim 18, wherein the substrate has a maximum temperature of about 600° C. to about 700° C.

20. The method of claim 18, wherein a time range, for which a temperature of the substrate is between the first temperature or higher and the second temperature or lower, is between about 0.004 seconds to about 0.005 seconds.
